(19) United States
(12) Patent Application Publication
(10) Pub. No.: US 2009/0303236 A1
(43) Pub. Date: Dec. 10, 2009

(54) METHOD AND SYSTEM FOR EXPLICIT CONTROL OF LIGHTING TYPE IN DIRECT VOLUME RENDERING

(75) Inventor: Georgiy Buyanovskiy, San Jose, CA (US)

Correspondence Address: MORRISON & FOERSTER LLP, 755 PAGE MILL RD, PALO ALTO, CA, 94304-1018, US

(73) Assignee: FOVIA, INC., Palo Alto, CA (US)

(21) Appl. No.: 12/333,199

(22) Filed: Dec. 11, 2008

Related U.S. Application Data
(60) Provisional application No. 61/059,635, filed on Jun. 6, 2008.

(51) Int. Cl. G06T 15/50

(52) U.S. Cl. 345/426

(57) ABSTRACT

Method and apparatus in computer enabled imaging for user control of the type of lighting applied to computer enabled volume rendering by means of an extended transfer function, by adding to the transfer function an additional user controlled parameter which explicitly specifies the type of lighting which is to be applied for all correspondent sample values.

### CROSS REFERENCE TO RELATED APPLICATION

This application claims priority to commonly invented U.S. provisional application No. 61/059,635, filed Jun. 6, 2008, incorporated herein by reference in its entirety.

### FIELD OF THE INVENTION

This disclosure relates to depiction of images of objects using computer enabled imaging, and especially to the lighting aspect of computer enabled imaging.

### BACKGROUND

Visualization of volumetric objects which are represented by three dimensional scalar fields is one of the most complete, realistic and accurate ways to represent internal and external structures of real 3-D (three dimensional) objects.

As an example, Computer Tomography (CT) digitizes images of real 3-D objects and represents them as a discrete 3-D scalar field representation. MRI (Magnetic Resonant Imaging) is another system to scan and depict internal structure of real 3-D objects.

As another example, the oil industry uses seismic imaging techniques to generate a 3-D image volume of a 3-D region in the earth. Some important geological structures, such as faults or salt domes, may be embedded within the region and are not necessarily on the surface of the region.

Direct volume rendering is a computer enabled technique developed for visualizing the interior of a solid region represented by such a 3-D image volume on a 2-D image plane, e.g., displayed on a computer monitor. Hence a typical 3-D dataset is a group of 2-D image “slices” of a real object generated by the CT or MRI machine or seismic imaging. Typically the scalar attribute or voxel (volume element) at any point within the image volume is associated with a plurality of classification properties, such as color—red, green, blue—and opacity, which can be defined by a set of lookup tables. A plurality of rays is cast from the 2-D image plane into the volume and they are attenuated or reflected by the volume. The amount of attenuated or reflected ray energy of each ray is indicative of the 3-D characteristics of the objects embedded within the image volume, e.g., their shapes and orientations, and further determines a pixel value on the 2-D image plane in accordance with the opacity and color mapping of the volume along the corresponding ray path. The pixel values associated with the plurality of ray origins on the 2-D image plane form an image that can be rendered by computer software on a computer monitor. A more detailed description of direct volume rendering is described in “Computer Graphics Principles and Practices” by Foley, Van Dam, Feiner and Hughes, 2nd Edition, Addison-Wesley Publishing Company (1996), pp 1134-1139.

In the CT example discussed above, even though a doctor using MRI equipment and conventional methods can arbitrarily generate 2-D image slices/cut of e.g. a heart by intercepting the image volume in any direction, no single image slice is able to visualize the whole surface of the heart. In contrast, a 2-D image generated through direct volume rendering of the CT image volume can easily reveal on a computer monitor the 3-D characteristics of the heart, which is very important in many types of cardiovascular disease diagnosis. Similarly in the field of oil exploration, direct volume rendering of 3-D seismic data has proved to be a powerful tool that can help petroleum engineers to determine more accurately the 3-D characteristics of geological structures embedded in a region that are potential oil reservoirs and to increase oil production significantly.

One of the most common and basic structures used to control volume rendering is the transfer function. In the context of volume rendering, a transfer function defines the classification/translation of the original pixels of volumetric data (voxels) to its representation on the computer monitor screen, particularly the commonly used transfer function representation which is color - red, green, blue - and opacity classification. Hence each voxel has a color and opacity value defined using a transfer function. The transfer function itself is mathematically, e.g., a simple ramp, a piecewise linear function or a lookup table. Computer enable volume rendering as described here may use conventional volume ray tracing, volume ray casting, splatting, shear warping, or texture mapping. More generally, transfer functions in this context assign renderable (by volume rendering) optical properties to the numerical values (voxels) of the dataset. The opacity function determines the contribution of each voxel to the final (rendered) image.

Even though direct volume rendering plays a key role in many important fields, several challenges need to be overcome to assure the most informative 2-D representation of volumetric 3-D objects. First, volumetric data may have varieties of properties and some of them may not be favorable for particular lighting techniques so the flexibility to control the type of applied lighting may be valuable tools to ensure the most informative representation of volumetric objects. (In this context, “lighting” refers to computer enabled imagery and how it is depicted by a computer system, not to actual lighting.)

Therefore, the present inventor has determined it would be desirable to increase flexibility to control the type of lighting for direct volume rendering that may increase the rendering efficiency and provide more readable 2-D representation of 3-D volumetric objects.

### SUMMARY

The present disclosure relates generally to the field of computer enabled volume data rendering, and more particularly, to a method and system for rendering a volume dataset using a transfer function representation having explicit control of the type of lighting per particular range of scalar field of volumetric data. One embodiment is a method and system for rendering a volume dataset using an extended transfer function representation for explicit control of type of lighting per particular range of scalar field of volumetric data. (“Lighting” here is used in the computer imaging sense, not referring to actual physical light.) One exemplary way to control the lighting property in accordance with the invention is explicitly to specify that gradient of scalar field must be used for computation of lighting, or if it should not be used. This approach is not limited to such gradient lighting control via an extension of the transfer function but rather is an example of such lighting control. Another example of the present lighting control is selection of which type of gradient lighting to apply, such as selecting the Phong or Blinn-Phong shading models, both well known in the field. Also, each particular type of lighting is associated with a set of parameters which may be uniquely specified for the particular data range which is a scalar field range along the X-axis of the transfer function. For example, the Phong shading model is associated with these four parameters: kₛ which are the specular reflection constant; k_{d} which is the diffuse reflection constant; kₐ which is the ambient reflection constant, and α which is the shininess constant for a material.

The present method and system add an additional user operated control parameter to an otherwise conventional transfer function where the parameter specifies the type of lighting which is to be applied for correspondent values of a scalar field. For example: the scalar field ranges which typically do not have steady gradients would likely appear as noise if gradient lighting is applied for this data range, so non-gradient based lighting is selected for this data range (the scalar field range). Steady gradient refers to the directions of neighboring lighting gradients being coherent, meaning the direction tend to have similar directions or the changing of directions is smooth at least up to the scale or sizes of the depicted structures. As described below, in one example the term “Lighting OFF” represents the case when gradient lighting is not used and the term “Lighting ON” represents the case when gradient lighting is used.

The method and system then apply the particular type of lighting for each sample event (a sample along a ray for ray casting or equivalent) according to the present lighting control parameter added to the transfer function. Note that if lighting for the current data range is gradient lighting, then the gradient associated with the sampled point is sampled or assessed also.

### BRIEF DESCRIPTION OF THE DRAWINGS

FIGS. 1(A) and 1(B) show respectively computer generated depictions of an image with respectively lighting OFF and ON for various control points as controlled by a user.

FIG. 2 shows in a block diagram a method and apparatus to carry out the process depicted in FIGS. 1(A) and 1(B).

### DETAILED DESCRIPTION

The aforementioned features and advantages of the invention as well as additional features and advantages thereof will be more clearly understood hereinafter as a result of a detailed description of embodiments of the invention when taken in conjunction with the drawings.

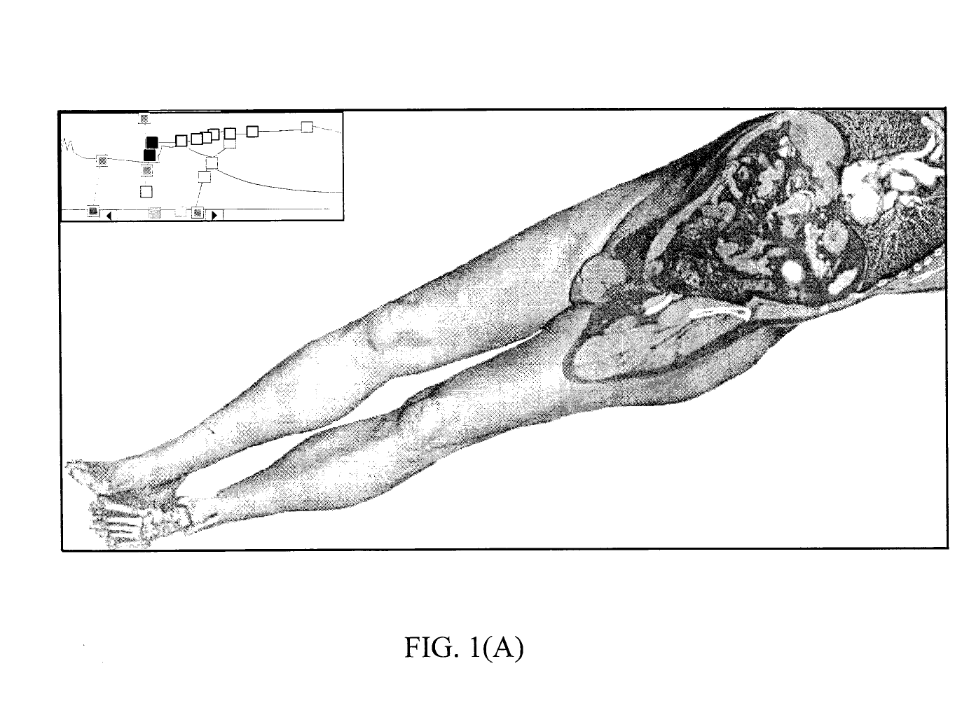

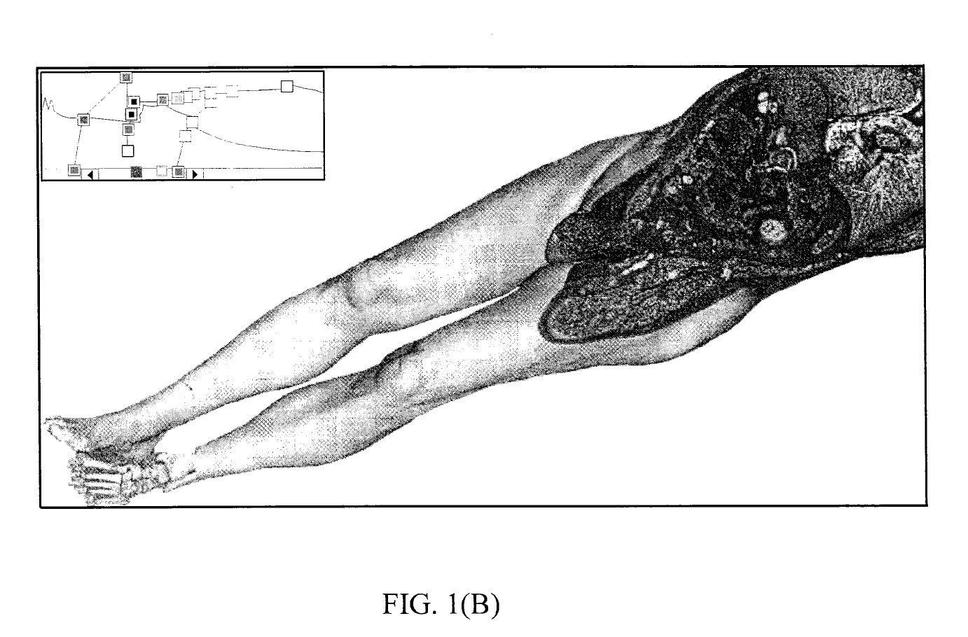

FIGS. 1(A) and 1(B) are two images representing respectively Lighting OFF/ON in accordance with the invention for an MPR (multi-planar reformation)-like cut of an MRI scan. FIG. 1(A) represents Lighting OFF and FIG. 1(B) represents Lighting ON. It can be seen that the transfer function (displayed here graphically at the left/top corner of each image) defines the non-gradient lighting for tissue ranges which represent tissues of internal organs. The user control points on the transfer function are represented by small colorized squares which all are contoured by a bright white contour for FIG. 1(B) that represents that gradient lighting is ON for all such control points on the transfer function of FIG. 1(B). In the case of FIG. 1(A) a subset of the control points are contoured by a dark contour that represents that gradient lighting is OFF for all such control points with a dark contour.

The user, by manipulating the control points on his computer screen by means of, e.g., a computer input device such as a mouse, can thereby turn the gradient lighting in this example on or off at each control point individually to optimize his view of the image. The gradient lighting in this example is turned on/off only for the data range associated with the portion of the transfer function extending from one user control point on the transfer function to the next control point along the X-axis of the transfer function. This X-axis defines the data values and scalar field values. The user thereby determines what sort of lighting to use based on, e.g., properties of the lighting gradients as he views the image.

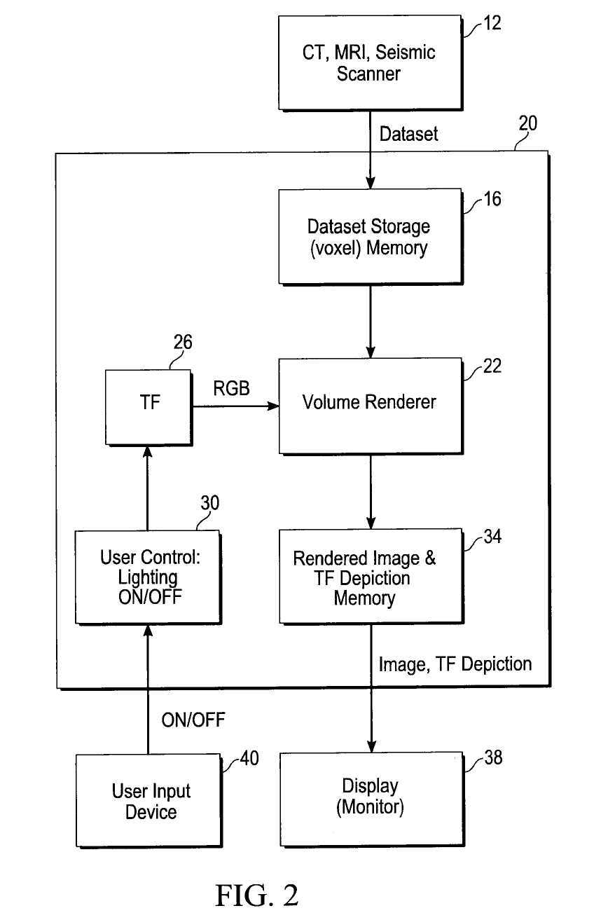

FIG. 2 depicts in a block diagram relevant portions of both the present method and the associated apparatus. A CT or MRI scanner or a seismic scanner 12 (not necessarily a part of the present apparatus) conventionally provides (as a computer data file) an image dataset which is stored in a conventional computer storage medium (memory) 16 as a set of voxels. Storage medium 16 is part of a computer-based imaging processing apparatus 20. The stored dataset is input to conventional volume renderer module 22 which is typically software executed on a processor 23. There is an associated (mostly) conventional transfer function (TF) software module 26 modified to accept, as described above, user control of the lighting parameter at the various control points via user control software module 30 from a user input device (e.g. a computer mouse) 40. Conventionally electrical signals are conveyed between the processor 23 and memories 16 and 34. The resulting rendered image and transfer function depiction are stored in computer storage (memory) 34, to be output to the user conventional display (monitor) 38.

In one embodiment the present method and apparatus to control the type of lighting therefore are embodied in computer software (code or a program) to be executed on a programmed computer or computing device 20. This code may be a separate application program and/or embedded in the transfer function representation. The input dataset (e.g. the CT data) may be provided live (in real time from a CT or MRI scanner or other source) or from storage as in FIG. 2, so the software may be resident in a standalone computer or in the computing portions of e.g. a CT or MRI machine or other platform. The computer software itself (coding of which would be routine in light of this disclosure) may be encoded in any suitable program language and stored on a computer readable medium in source code or compiled form. The output images of FIGS. 1(A) and 1(B) themselves are typically also stored in a computer readable medium (memory) in the computer.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer enabled method of depicting an image, comprising the acts of:
providing a dataset representing an image in 3 dimensions, wherein the dataset includes a plurality of elements;
providing a transfer function which defines a color and opacity for each of the elements, wherein the transfer function includes a parameter selected by a user and defining a type of lighting for at least some of the plurality of elements;
volume rendering an output of the transfer function to provide a 2-dimensional projection of the output; and
displaying the volume rendered 2-dimensional projection.

2. The method of claim 1, wherein the transfer function defines the color as red, green, blue and the opacity as a fraction.

3. The method of claim 1, wherein the type of lighting is one of gradient based lighting or non-gradient based lighting.

4. The method of claim 3, wherein the user establishes the relation of the type of gradient based lighting to a scalar value of each element.

5. The method of claim 3, wherein the user establishes the relation of the type of non-gradient based lighting to a scalar value of each element.

6. The method of claim 3, wherein the non-gradient based lighting is selected by the user for elements having non-coherent gradients of scalar field between nearly elements.

7. The method of claim 1, wherein the type of lighting is defined by a classification and lighting model.

8. The method of claim 1, each element being a volume element.

9. The method of claim 1, wherein the volume rendering includes performing one of volumetric ray-tracing, volumetric ray-casting, splatting, shear warping, or texture mapping.

10. The method of claim 1, wherein the transfer function is one of a ramp function, a piecewise linear function, or a lookup table.

11. The method of claim 1, further comprising the acts of:
displaying along with the projection a depiction of the transfer function including a plurality of control points; and
accepting input from the user at each control point to select a value of the parameter for a portion of the projection associated with that control point.

12. A computing device programmed to carry out the method of claim 1.

13. A computer readable medium storing the projection produced by the method of claim 1.

14. A computer readable medium storing computer code to carry out the method of claim 1.

15. Apparatus for depicting an image, comprising:
a first storage for storing a dataset representing an image in 3 dimensions, wherein the dataset includes a plurality of elements;
a processor coupled to the first storage;
a transfer function portion which defines a color and opacity for each of the elements responsive to a parameter selected by a user defining a type of lighting for at least some of the elements;
a volume renderer element coupled to the transfer function element and the processor which renders an output of the transfer function element to provide a 2-dimensional projection of the output; and
a second storage coupled to store an output of the volume renderer element.

16. The apparatus of claim 15, wherein the transfer function portion defines the color as red, green, blue and the opacity as a fraction.

17. The apparatus of claim 15, wherein the type of lighting is one of gradient based lighting or non-gradient based lighting.

18. The apparatus of claim 17, further comprising a user input device coupled to the transfer function element wherein a user establishes the relation of the type of gradient based lighting to a scalar value of each element.

19. The apparatus of claim 17, further comprising a user input device coupled to the transfer function element wherein a user establishes the relation of the type of non-gradient based lighting to a scalar value of each element.

20. The apparatus of claim 17, wherein the non-gradient based lighting is selected for elements having non-coherent gradients of scalar field between nearly elements.

21. The apparatus of claim 15, wherein the type of lighting is defined by a classification and lighting model.

22. The apparatus of claim 15, each element being a volume element.

23. The apparatus of claim 15, wherein the volume renderer element performs one of volumetric ray-tracing, volumetric ray-casting, splatting, shear warping, or texture mapping.

24. The apparatus of claim 15, wherein the transfer function portion performs one of a ramp function, a piecewise linear function, or consulting a lookup table.

25. The method of claim 15, wherein the volume renderer element:
rendering along with the projection a depiction of the transfer function including a plurality of control points;
and the apparatus further comprising:
a user input device coupled to the transfer function element for accepting input from a user at each control point to select a value of the parameter for a portion of the projection associated with that control point.
